(19) United States
(12) Patent Application Publication
(10) Pub. No.: US 2025/0360569 A1
(43) Pub. Date: Nov. 27, 2025

(54) 3D PRINTING POWDER SPREADING APPARATUS AND METHOD AND 3D PRINTING DEVICE

(71) Applicant: AIXWAY3D (JIANGSU) CO.,LTD, Suzhou (CN)

(72) Inventor: LIYAOWEI SHEN, Suzhou (CN)

(73) Assignee: AIXWAY3D (JIANGSU) CO.,LTD, Suzhou (CN)

(21) Appl. No.: 19/292,126

(22) Filed: Aug. 6, 2025

Related U.S. Application Data
(63) Continuation of application No. PCT/CN2023/114018, filed on Aug. 21, 2023.

(30) Foreign Application Priority Data
Dec. 26, 2022 (CN) 202211671468.4

(51) Int. Cl. B22F 12/57; B22F 12/52; B22F 12/63; B22F 12/90; B29C 64/153; B29C 64/188; B29C 64/218; B29C 64/255; B29C 64/314; B29C 64/343; B29C 64/386; B33Y 30/00; B33Y 40/10; B33Y 50/00

(52) U.S. Cl. CPC B22F 12/57; B22F 12/52; B22F 12/63; B22F 12/90; B29C 64/153; B29C 64/188; B29C 64/218; B29C 64/255; B29C 64/314; B29C 64/343; B29C 64/386; B33Y 30/00; B33Y 40/10; B33Y 50/00

(57) ABSTRACT

The present invention provides a 3D printing powder spreading apparatus and method and a 3D printing device, the powder overflowing from the powder tank (10) is conveyed into a vibrating sieve (12) by means of a first powder spreading part (11); the vibrating sieve (12) vibrates at a certain frequency to vibrate and sieve the powder entering the vibrating sieve (12), so that the powder is spread out and made looser; then a plasma mechanism (13) releases plasma to the powder sieved from the vibrating sieve (12) so as to remove the static electricity of the powder, and additionally, raised burrs on the surfaces of ultrafine powder particles can be quickly melted and spheroidized in a high-pressure plasma environment, and the melted and spheroidized ultrafine powder is scattered on a forming platform (14).

### CROSS-REFERENCE TO RELATED APPLICATIONS

The present application claims the right of priority for Chinese Patent Application No. 202211671468.4, filed with the China National Intellectual Property Administration on Dec. 26, 2022, which is incorporated herein by reference in its entirety.

### TECHNICAL FIELD

The present invention relates to the field of 3D printing, and in particular to a 3D printing powder spreading apparatus and a method and a 3D printing device

### BACKGROUND

In the process of constructing a part via three-dimensional (3D) printing, it is common to segment the part into a plurality of two-dimensional planar structures, and then finally fabricate the part by printing layer by layer in sequence. Especially for the powder bed sintering/melting technology, the process involves spreading a thin layer of metal/non-metal powder layer by layer, followed by selective sintering or melting of the layer of powder using a heat source (usually a laser) to form a structure of the part in the layer, and the construction of the part is finally completed by spreading the powder layer by layer. For the powder bed-based 3D printing technology at present, a powder material is usually required to exhibit good flowability and an appropriate particle size to ensure the uniformity and integrity of each layer of spread powder. Therefore, the powder used is usually required to have high sphericity and uniform particle size. However, the traditional powder bed fusion 3D printing has a large powder particle size, which is not conducive to forming a high-precision part, resulting in rough surface finishes of the 3D-printed part. When the particle size is further reduced, and ultrafine powder is used for powder spreading, a surface area of the powder layer formed by the ultrafine powder will increase sharply, which will seriously affect the uniformity and completeness of the powder layer.

### SUMMARY

In order avoid agglomeration of ultrafine powder and to achieve uniform distribution of the ultrafine powder on a forming platform, one aspect of the present invention provides a 3D printing powder spreading apparatus, including: a powder tank configured to store powder for use in 3D printing, where the powder tank can be driven under the action of a driving device to cause part of the powder to overflow from the powder tank; a first powder spreading part configured to convey the powder overflowed from the powder tank in a direction away from the powder tank; a plasma mechanism disposed in a discharge direction of the powder after being conveyed by the first powder spreading part and configured to release plasma to the powder to eliminate static electricity and/or to melt burrs of the powder; and a forming platform disposed in a discharge direction of the powder after being processed by the plasma mechanism, and configured to receive the powder discharged from the plasma mechanism, where the powder is evenly spread on the forming platform.

Preferably, the 3D printing powder spreading apparatus further includes at least one vibrating sieve disposed in a direction that the first powder spreading part conveys the powder and configured to receive the powder conveyed by the first powder spreading part and to perform vibratory sieving to achieve loosening treatment.

Preferably, the 3D printing powder spreading apparatus further includes a second powder spreading part configured to roll the powder entering the vibrating sieve to preliminarily loosen the powder.

Preferably, the second powder spreading part is a roller, a lateral surface of the roller is provided with a plurality of raised portions and a plurality of recessed portions at intervals, and a distance between a highest point of the raised portion and a lowest point of the recessed portion is set to 50-300 μm.

Preferably, the vibrating sieve is a groove-type sieve and/or a perforated sieve.

Preferably, the groove-type sieve includes a plurality of powder sieving grooves arranged at intervals, and the powder sieving grooves extend from one end of the groove-type sieve parallel to the direction that the first powder spreading part conveys the powder to the other end.

Preferably, in the direction that the first powder spreading part conveys the powder, groove widths of the powder sieving grooves gradually increase, for example, the groove widths may increase from at least 0.2 mm to 2 mm.

Preferably, the perforated sieve includes a plurality of powder sieving holes arranged at intervals, and each powder sieving hole has a diameter of 10-30 μm.

Preferably, two vibrating sieves are provided, one of them is configured as the groove-type sieve, and the other is configured as the perforated sieve; and one of the vibrating sieves is arranged in the discharge direction of the powder after being sieved by the other vibrating sieve.

Preferably, the 3D printing powder spreading apparatus further includes an ultrasonic mechanism configured to preliminarily loosen the powder entering the vibrating sieve through ultrasonic waves.

Preferably, the plasma mechanism is in a moving state or in a stationary state in the three-dimensional space.

Preferably, when the plasma mechanism is in a moving state, the powder discharged from the plasma mechanism after treatment is spread on the forming platform with a predetermined layer thickness.

Preferably, the 3D printing powder spreading apparatus further includes a distance sensor for determining a thickness of a layer of spread powder by measuring a difference between a distance from a previous layer of powder to a standard position and a distance from a current layer of powder after spreading to the standard position.

Preferably, the plasma mechanism moves in synchronization with the powder tank and the vibrating sieve in the three-dimensional space.

Preferably, the 3D printing powder spreading apparatus further includes a third powder spreading part configured to further spread the powder already laid on the forming platform.

Preferably, the third powder spreading part is implemented as a roller, the roller moves in the powder spreading direction and/or opposite to the powder spreading direction, thereby controlling the thickness and/or uniformity of the powder spread on the forming platform.

Preferably, when the plasma mechanism is in the moving state in the three-dimensional space, the third powder spreading part moves in synchronization with the powder tank, the vibrating sieve and the plasma mechanism.

Preferably, the movement of the third powder spreading part is driven and controlled by a separate power source.

Preferably, the third powder spreading part includes a heating unit for heating a surface of the third powder spreading part to transfer heat to the powder spread on the forming platform.

Preferably, the 3D printing powder spreading apparatus further includes a heating device disposed above the forming platform for heating the powder spread on the forming platform via thermal radiation.

Preferably, the plasma mechanism includes a powder dropping channel and at least one plasma generator arranged on the powder dropping channel; and after the conveyed and discharged powder enters the powder dropping channel, the plasma generator releases plasma to the powder entering the powder dropping channel to eliminate static electricity and/or to melt burrs of the powder.

Preferably, a vibrating frequency of the vibrating sieve is 500-3000 Hz.

In order avoid agglomeration of ultrafine powder and to achieve uniform distribution of the ultrafine powder on a forming platform, another aspect of the present invention provides a 3D printing device, the 3D printing device includes a structure configured to mount the aforementioned 3D printing powder spreading apparatus into the 3D printing device.

In the present invention, the powder tank is driven to move so as to cause part of powder to overflow from the powder tank; the powder overflowing from the powder tank is conveyed to a direction away from the powder tank, a plasma mechanism releases plasma to the sieved powder after being conveyed by the first powder spreading part so as to remove the static electricity of the powder, and additionally, raised burrs on the surfaces of ultrafine powder particles can be quickly melted and spheroidized in a high-pressure plasma environment, and the melted and spheroidized ultrafine powder is scattered on a forming platform, so that the treated powder is uniformly spread on the forming platform. In this way, the ultrafine powder can be uniformly and completely spread on the forming platform by using the 3D printing powder spreading apparatus of the present invention, so that parts having higher precision can be formed. In addition, the present invention further provides a vibrating sieve arranged in the direction in which the first powder spreading part conveys the powder, so as to receive the powder conveyed by the first powder spreading part and perform vibratory sieving of the powder, thereby loosening the powder and making it more dispersed.

### BRIEF DESCRIPTION OF DRAWINGS

FIG. 1 is a schematic diagram of a 3D printing powder spreading apparatus before powder spreading according to an embodiment of the present invention.

FIG. 2 is a schematic diagram of a 3D printing powder spreading apparatus after powder spreading according to an embodiment of the present invention.

FIG. 3 is a schematic diagram illustrating movements of a powder tank relative to a vibrating sieve along an X-axis according to an embodiment of the present invention.

FIG. 4 is a schematic diagram illustrating movements of a vibrating sieve relative to a plasma mechanism along a Y-axis according to an embodiment of the present invention.

FIG. 5 is a schematic diagram illustrating arrangement of a third powder spreading part according to one embodiment of the present invention.

FIG. 6 is a schematic diagram illustrating arrangement of a third powder spreading part according to another embodiment of the present invention.

FIG. 7 is a schematic diagram illustrating arrangement of a second powder spreading part according to an embodiment of the present invention.

FIG. 8 is a schematic structural diagram of a second powder spreading part according to an embodiment of the present invention.

FIG. 9 is a schematic diagram illustrating arrangement of an ultrasonic mechanism according to an embodiment of the present invention.

FIG. 10 is a schematic diagram illustrating arrangement of two vibrating sieves according to an embodiment of the present invention.

FIG. 11 is a schematic diagram of a surface of a groove-type sieve according to an embodiment of the present invention.

FIG. 12 is a schematic diagram of a surface of a perforated sieve according to an embodiment of the present invention.

FIG. 13 is a schematic diagram illustrating arrangement of a heating device according to an embodiment of the present invention.

FIG. 14 is a schematic diagram illustrating arrangement of a mechanical unit of a 3D printing device according to an embodiment of the present invention.

FIG. 15 is a schematic diagram illustrating movement trajectories of a powder spreading mechanism, a forming chamber, and an optical path unit according to one embodiment of the present invention.

FIG. 16 is a schematic diagram illustrating movement trajectories of a powder spreading mechanism, a forming chamber, and an optical path unit according to another embodiment of the present invention.

FIG. 17 is a schematic diagram illustrating movement trajectories of a powder spreading mechanism, a forming chamber, and an optical path unit according to yet another embodiment of the present invention.

FIG. 18 is a flowchart of a 3D printing powder spreading method according to one embodiment of the present invention.

FIG. 19 is a flowchart of a 3D printing powder spreading method according to another embodiment of the present invention.

FIG. 20 illustrates: (a) a schematic diagram of powder agglomeration; (b) a schematic diagram illustrating ordinary powder spreading effect; and (c) a schematic diagram illustrating powder spreading effect according to the present invention.

### DETAILED DESCRIPTION OF THE EMBODIMENTS

According to one aspect of the present invention, a 3D printing powder spreading apparatus is provided. The apparatus is used in a 3D printing device, that is, it may serve as a part of a structure of the 3D printing device. The 3D printing device described herein is preferably a 3D printing type that uses a laser beam/electron beam as an energy source, such as selective laser sintering (SLS) and selective laser melting (SLM). The powder bed-based 3D printing technology requires a powder material to be spread in advance. The powder material is then melted by a laser to fuse the loose powder together, a powder material is scanned and spread layer by layer, a forming platform descends after each layer is completed, and a solid body wrapped by the powder is finally obtained.

In terms of components, a 3D printing device usually includes at least a mechanical unit, an optical path unit, and a computer control system. The 3D printing powder spreading apparatus of the present invention is preferably used as a part of the mechanical unit. Alternatively, it may also serve as a standalone module alongside the mechanical unit, the optical path unit, and the computer control system. In a specific spatial arrangement, the optical path unit may be disposed above the mechanical unit. Alternatively, it may be disposed based on the core inventive concepts of the present invention. In terms of control logic, both the mechanical unit and the optical path unit are controlled by the computer control system, that is, the 3D printing powder spreading apparatus of the present invention is preferably controlled by the computer control system.

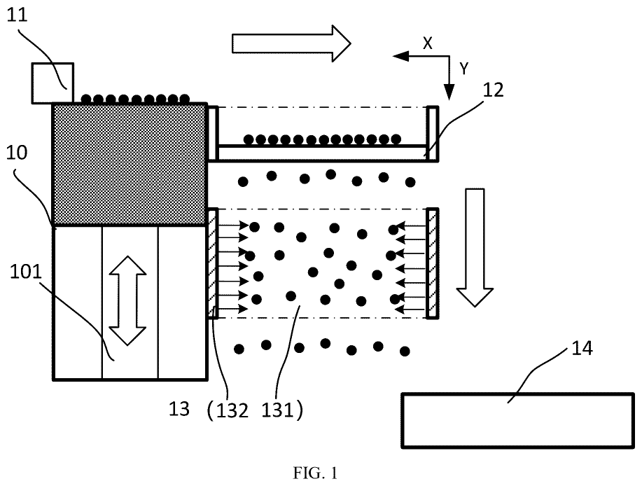

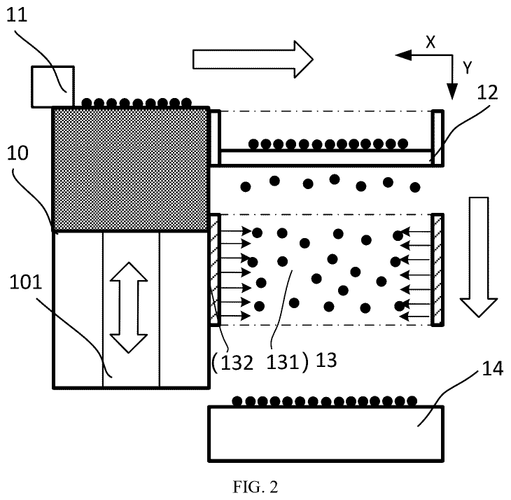

As shown in FIGS. 1 and 2, in some embodiments, the 3D printing powder spreading apparatus of the present invention includes at least a powder tank 10, a first powder spreading part 11, a vibrating sieve 12, a plasma mechanism 13, and a forming platform 14.

The powder tank 10 is configured to store powder used for 3D printing. The powder described herein refers to a material to be processed, which is used in a powder state. For example, the powder may primarily be composed of a material made of metal and polymer. Specifically, the powder described herein is preferably ultrafine powder, and alternatively, it may also be preferably used in non-ultrafine powder. The ultrafine powder described herein usually has a particle size of less than 20 μm.

The powder tank 10 is configured to allow part of the powder to overflow from the powder tank 10 under the action of a drive device. In one embodiment, the drive device is a powder-supplying lift mechanism 101, that is, the powder-supplying lift mechanism drives the powder tank 10 to move upward or downward. When the powder-supplying lift mechanism 101 drives the powder tank 10 to move upward, part of the powder stored in the powder tank 10 is driven to overflow from the powder tank 10. It should be understood that, in this embodiment, a piston in the powder tank 101 is driven by the powder-supplying lift mechanism 101, which moves upward to discharge powder for spreading. In another embodiment, a top-feeding powder conveying method may be used, such that the first powder spreading part 11 conveys the powder in a direction away from the powder tank 101. Specifically, the top-feeding powder conveying method uses a powder dropping mechanism (not shown in the figure). Driven by the drive device, the powder dropping mechanism is capable of continuously dispensing powder at a front end of a movement direction of the first powder spreading part 11 from a powder falling port, and the dispensed powder is conveyed to the direction away from the powder tank 101 under the action of the first powder spreading part 11.

The first powder spreading part 11 is disposed above the powder tank 10 and is capable of moving along an X-axis above the powder tank 10, as well as conveying the powder that has overflowed from the powder tank 10 in the direction away from the powder tank 10 due to the movement above the powder tank 10, and specifically conveying the powder to the vibrating sieve 12. A specific form of the first powder spreading part 11 may be one of a powder spreading brush, a powder spreading roller, or a scraper. In the present invention, the first powder spreading part is preferably a scraper.

The vibrating sieve 12 is disposed in a direction that the first powder spreading part conveys the powder 11, and may also be understood as being disposed on a side adjacent to the powder tank 10, for example, it is disposed on a left side or a right side of the powder tank 10. The vibrating sieve 12 is configured to receive the powder overflowed from the powder tank 10 conveyed by the first powder spreading part 11, and to perform vibratory sieving for loosening the powder. A vibrating frequency of the vibrating sieve 12 is set to 500-3000 Hz, and preferably 500 Hz. It should be understood that the vibrating sieve 12 is composed of a sieve body and a vibration device (such as a vibrating motor) capable of exciting and driving the sieve body to vibrate in practical applications.

The plasma mechanism 13 is disposed in a discharge direction after being sieved by the vibrating sieve 12. It should be understood that the plasma mechanism is disposed below the vibrating sieve 12, and a side adjacent to the powder tank 10. The plasma mechanism 13 is configured to release plasma to the powder sieved from the vibrating sieve 12, thereby eliminating static electricity and/or to melt burrs of the powder. The plasma mechanism 13 includes a powder dropping channel 131 and one or more plasma generators 132 arranged on the powder dropping channel 131. After passing through the vibrating sieve 12, the powder enters the powder dropping channel 131. The plasma generators 132 then release plasma to the powder entering the powder dropping channel 131 to eliminate static electricity and/or to melt burrs of the powder. In one embodiment, two plasma generators 132 are symmetrically arranged at interval, and an interval area in a middle forms the powder dropping channel 131. In another embodiment, the powder dropping channel 131 is configured as a housing with both top and bottom openings, and the plasma generators 132 are arranged in a circumferential direction along the powder dropping channel 131.

The forming platform 14 is disposed in a discharge direction of the powder after being processed by the plasma mechanism 13, and is configured to receive the powder discharged from the plasma mechanism 13, and the powder is evenly spread on the forming platform 14.

In the traditional 3D powder spreading process, a scraper is used to directly spread the powder that overflows from the powder tank onto the forming platform, thereby forming a layer of powder for constructing the part. A heat source such as a laser is used to scan layer of powder in a specified path to form a layer of cross-sectional structure of the part. However, for the ultrafine powder spreading provided in the present invention, it is difficult for the ultrafine powder to form a uniform and complete layer of powder in the forming platform due to agglomeration and other factors.

In contrast, for the 3D printing powder spreading apparatus formed by the aforementioned components (the powder tank 10, the first powder spreading part 11, the vibrating sieve 12, the plasma mechanism 13, and the forming platform 14) provided by the present invention, the powder overflowing from the powder tank 10 is conveyed into a vibrating sieve 12 by means of a first powder spreading part 11; the vibrating sieve 12 vibrates at a certain frequency to vibrate and sieve the powder entering the vibrating sieve 12, so that the powder is spread out and made looser; then a plasma mechanism 13 releases plasma to the sieved powder from the vibrating sieve 12 so as to remove the static electricity of the powder, and additionally, raised burrs on the surfaces of ultrafine powder particles can be quickly melted and spheroidized in a high-pressure plasma environment, and the melted and spheroidized ultrafine powder is scattered on a forming platform 14, so that the treated powder is uniformly deposited on the forming platform 14.

Optionally, in some embodiments, the 3D printing powder spreading apparatus of the present invention includes at least a powder tank 10, a first powder spreading part 11, a plasma mechanism 13, and a forming platform 14, that is, the powder conveyed by the first powder spreading part 11 directly enters the plasma mechanism 13 without being sieved by the vibrating sieve 12. In this configuration, the plasma mechanism 13 is disposed in a discharge direction of the powder after being conveyed by the first powder spreading part 11, and is configured to release plasma to the powder to eliminate static electricity and/or to melt burrs of the powder. Specifically, the powder discharging from the first powder spreading part 11 enters the powder dropping channel 131, and the plasma generators 132 are configured to release plasma to the powder entering the powder dropping channel 131 to eliminate static electricity and/or to melt burrs of the powder.

For the 3D printing powder spreading apparatus formed by the aforementioned components (the powder tank 10, the first powder spreading part 11, the plasma mechanism 13, and the forming platform 14) provided by the present invention, the powder overflowing from the powder tank 10 is conveyed into the plasma mechanism 13 through the first powder spreading part 11, and the plasma mechanism 13 then releases plasma to the powder to remove the static electricity of the powder, and additionally, raised burrs on the surfaces of ultrafine powder particles can be quickly melted and spheroidized in a high-pressure plasma environment, and the melted and spheroidized ultrafine powder is scattered on the forming platform 14, so that the treated powder is uniformly spread on the forming platform 14.

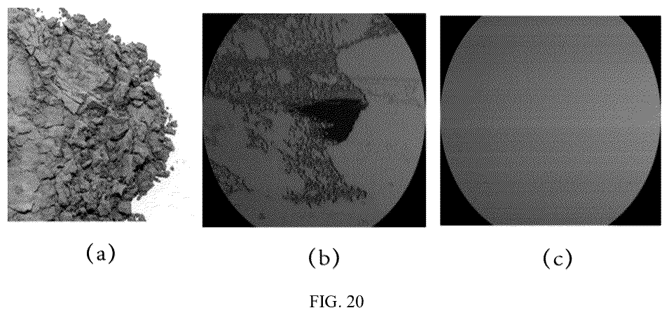

As shown in FIG. 20, it can be seen that the ultrafine powder spread using the 3D printing powder spreading apparatus of the present invention is uniformly distributed on the forming platform 14.

In some embodiments, the plasma mechanism 13 is movable in three-dimensional space, and the forming platform 14 is stationary in the three-dimensional space. In X-Y-Z three-dimensional space, the plasma mechanism 13 may move along an X-axis and/or a Y-axis and/or a Z-axis relative to the forming platform 14, such that the powder discharged from the plasma mechanism 13 after treatment can be spread on the forming platform 13 with a predetermined layer thickness, thereby achieving uniform powder spreading on the forming platform 13.

The powder spreading method can spread powder on the forming platform 14 in a non-contact method, that is, compared with the conventional scraper-based spreading method, the non-contact powder spreading method may greatly reduce the damage to the component structure already formed on the powder bed. In some embodiments, the powder spreading using the method allows for the formation of a cantilevered structure in the printed part without requiring additional support structures, or even enables printing in a stacked manner.

The plasma mechanism 13 is configured to move in the three-dimensional space in synchronization with the powder tank 10 and the vibrating sieve 12, that is, all three components are movable in the three-dimensional space.

In one embodiment, the powder tank 10 is connected to both the plasma mechanism 13 and the vibrating sieve 12, for example, an integral structure or connectors (such as bolts) are used to allow for detachable connection between the powder tank 10 and the plasma mechanism 13 and the vibrating sieve 12. In a connected state, the three components share a common drive mechanism, which enables the control of combined movement in the three-dimensional space. In another embodiment, the powder tank 10, the plasma mechanism 13, and the vibrating sieve 12 are arranged separately, and are driven independently by their respective drive mechanisms, which allow for synchronized or unsynchronized driving control of the movement states of the three components, such that the powder tank 10, the plasma mechanism 13, and the vibrating sieve 12 synchronously in the three-dimensional space under the synchronized driving control, and at least the plasma mechanism 13 can move relative to the forming platform 14 along the X-axis and/or Y-axis and/or Z-axis under the unsynchronized driving control. Preferably, the former control method is adopted in the present invention, that is, the powder tank 10 is connected to both the plasma mechanism 13 and the vibrating sieve 12, and the three components share a common drive mechanism, which enables the control of combined movement in the three-dimensional space. On this basis, the movement state of the plasma mechanism 13 relative to the forming platform 14 may be understood as the movement state of an assembly formed by the powder tank 10, the plasma mechanism 13, and the vibrating sieve 12 relative to the forming platform 14.

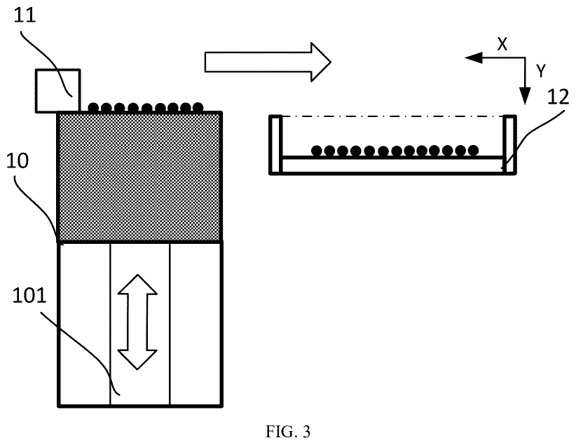

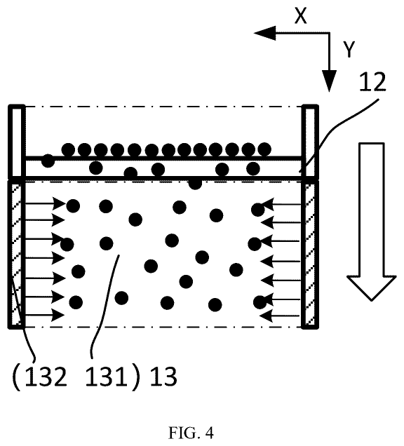

In the configuration that the powder tank 10, the plasma mechanism 13, and the vibrating sieve 12 are arranged separately, and are driven independently by their respective drive mechanisms, which allow for unsynchronized driving control of the movement states of the three components, as shown in FIG. 3, the powder tank 10 can be controlled by its corresponding drive mechanism to move along the powder conveying direction (the X-axis) of the first powder spreading part 11 when the powder overflows, thereby gradually approaching the vibrating sieve 12. After contacting the vibrating sieve 12, the powder tank stops moving and triggers the first powder spreading part 11 to perform the powder conveying operation. As shown in FIG. 4, the vibrating sieve 12 can be driven by its respective drive mechanism to move in the discharge direction (the Y-axis) of the powder after being sieved by the vibrating sieve 12, thereby gradually approaching the plasma mechanism 13, and reducing a powder dropping distance between the vibrating sieve 12 and the plasma mechanism 13.

In some embodiments, the 3D printing powder spreading apparatus of the present invention further includes a distance sensor (not shown in the figures) for measuring a difference between a distance from a previous layer of powder to a standard position and a distance from a current layer of powder after spreading to the standard position, to obtain a thickness of the spread layer of powder. The term “standard position” described herein refers to a position where the distance sensor is located. It should be understood that a thickness of the first powder layer is a difference between a distance from an upper surface of the forming platform 14 to the standard position and a distance from the surface of a first layer of powder to the standard position. The distance sensor may be any one of an ultrasonic distance sensor, a laser distance sensor, an infrared distance sensor, or a millimeter-wave radar sensor.

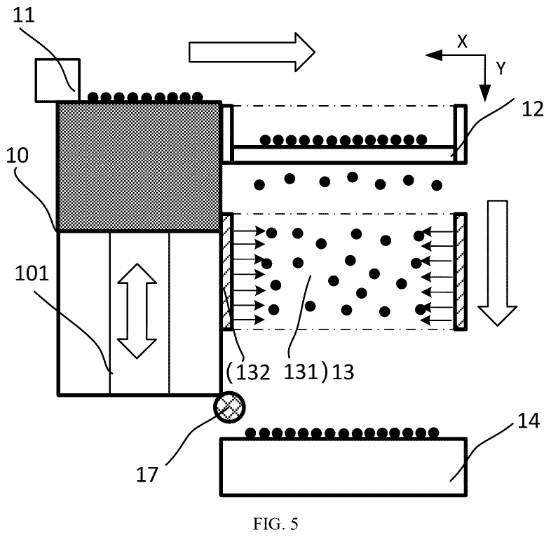

As shown in FIG. 5, in some embodiments, the 3D printing powder spreading apparatus further includes a third powder spreading part 17, which is configured to further spread the powder already laid on the forming platform 14. The third powder spreading part 17 may be implemented as a roller, which is capable of moving in the powder spreading direction and/or opposite to the powder spreading direction, thereby controlling the thickness and/or uniformity of the powder spread on the forming platform 14. When the plasma mechanism 13 is in a moving state in the three-dimensional space, the movement of the third powder spreading part 17 moves in synchronization with the powder tank 10, the vibrating sieve 12, and the plasma mechanism 13, that is, it is also in a moving state in the three-dimensional space, and moves in synchronization with the powder tank 10, the vibrating sieve 12, and the plasma mechanism 13. In order to achieve a synchronized moving state, in one embodiment, the powder tank 10 is connected to both the plasma mechanism 13 and the vibrating sieve 12, and the three components share a common drive mechanism, which enables the control of combined movement in the three-dimensional space, the third powder spreading part 17 is also connected to the powder tank 10 (integrally formed or detachably connected), for example, it is arranged at a lower right corner of the powder tank as shown in FIG. 5. In a connected state, the third powder spreading part 17 can be driven by the powder tank 10 to achieve synchronous movement, and can also be understood as being driven synchronously with the powder tank 10, the plasma mechanism 13, and the vibrating sieve 12. Accordingly, the third powder spreading part 17 moves on the forming platform 14 in the powder spreading direction and/or opposite to the powder spreading direction, thereby controlling the thickness and/or uniformity of the powder spread on the forming platform 14.

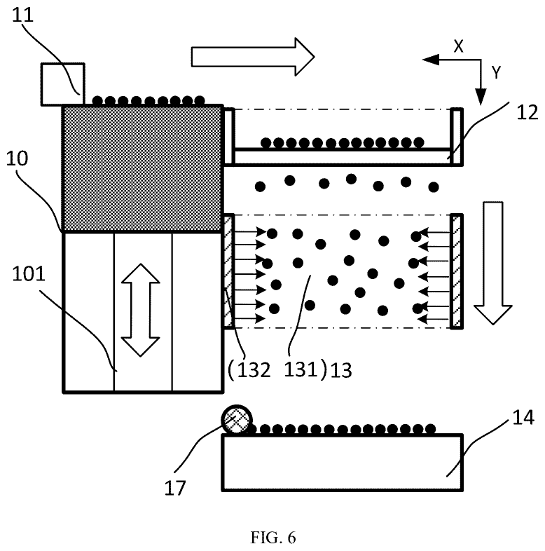

As shown in FIG. 6, in some embodiments, the movement of the third powder spreading part 17 is driven and controlled by a separate power source, that is, the third powder spreading part 17 is disposed on the forming platform 14, and the third powder spreading part 17 is driven by a separate drive mechanism to move on the forming platform 14 in the powder spreading direction and/or opposite to the powder spreading direction, thereby controlling the thickness and/or uniformity of the powder spread on the forming platform 14. On the basis that the movement of the third powder spreading part 17 is driven by a separate drive mechanism, movement states of the powder tank 10, the plasma mechanism 13, and the vibrating sieve 12 in the three-dimensional space may either be in the aforementioned moving state or in a stationary state. In the stationary state, powder drops from the plasma mechanism 13 onto the forming platform 14 in a free-falling manner, and the third powder spreading part 17 is then controlled to move in the powder spreading direction and/or opposite to the powder spreading direction on the forming platform 14 to perform the powder spreading operation.

In some embodiments, the third powder spreading part 17 includes a heating unit (not shown in the figures), which may be disposed inside the third powder spreading part 17, such that a surface of the third powder spreading part 17 is heated when the third powder spreading part 17 moves to spread powder on the forming platform 17, thereby transferring heat on the surface of the third powder spreading part 17 to the powder spread on the forming platform 14, and facilitating further dispersion of the powder.

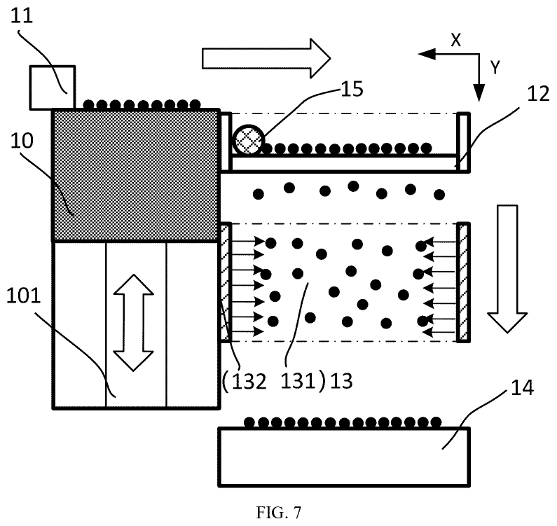

As shown in FIG. 7, in some embodiments, the 3D printing powder spreading apparatus of the present invention further includes a second powder spreading part 15, which is disposed in the vibrating sieve 12 and is configured to move in the vibrating sieve 12 in the powder spreading direction and/or opposite to the powder spreading direction, so as to roll the powder entering the vibrating sieve 12 to preliminarily loosen the powder.

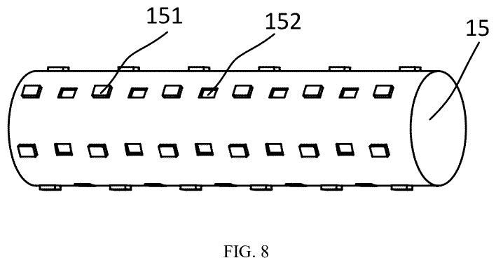

As shown in FIG. 8, in some embodiments, the second powder spreading part 15 may be a roller, a lateral surface of the roller is provided with a plurality of raised portions 151 and a plurality of recessed portions 152 at intervals, and the raised portions 151 and the recessed portions 152 are preferably arranged at intervals. The lateral surface of the roller serves as a rolling surface when it rolls inside the vibrating sieve 12. A distance between a highest point of the raised portion 151 and a lowest point of the recessed portion 152 is set to 50-300 μm. It should be understood that the raised portions 151 and the recessed portions 152 shown in FIG. 8 are equivalent to a size of the roller only for the convenience of illustrating their structural relationship, and do not reflect the actual dimensional ratio in application. By controlling the roller to roll the powder entering the vibrating sieve 12, the ultrafine powder entering the vibrating sieve 12 can be preliminarily loosened, thereby loosening the agglomerated powder.

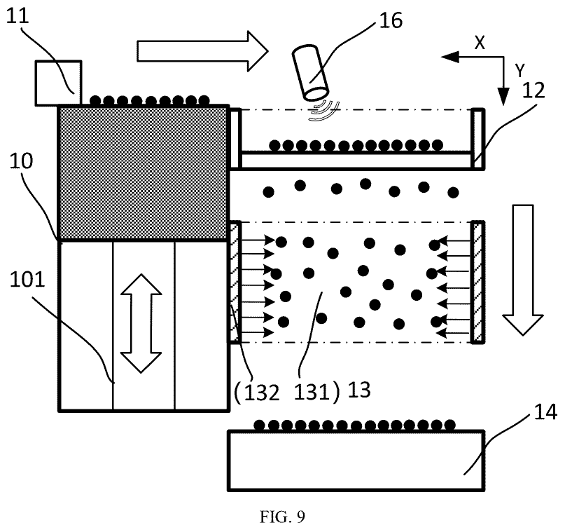

As shown in FIG. 9, in some embodiments, the 3D printing powder spreading apparatus of the present invention further includes an ultrasonic unit 16 disposed above the vibrating sieve 12. The ultrasonic unit 16 may be specifically an ultrasonic generator capable of generating ultrasonic waves to perform ultrasonic vibration on the powder entering the vibrating sieve 12, thereby performing preliminary loosening of the powder entering the vibrating sieve 12. It should be understood that in the embodiments of the present invention, both the second powder spreading part 15 and the ultrasonic unit 16 may be used concurrently to perform the preliminary loosening of powder in the vibrating sieve 12.

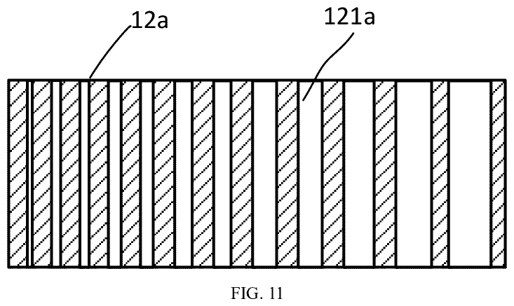

As shown in FIG. 11, in some embodiments, the vibrating sieve 12 may be configured as a groove-type sieve 12a. The groove-type sieve 12a includes a plurality of powder sieving grooves 121a arranged at intervals. The powder sieving grooves 121a extend from one end of the groove-type sieve 12a parallel to the direction that the first powder spreading part conveys the powder 11 to the other end. In the direction that the first powder spreading part conveys the powder 11, groove widths of the powder sieving grooves 121a gradually increase, for example, the groove widths may increase from at least 0.2 mm to 2 mm. It should be understood that a groove width of the powder sieving groove 121a closest to the powder tank 10 is set to 0.2 mm, a groove width of the powder sieving groove 121a farthest from the powder tank 10 is set to 2 mm, and a groove width of the powder sieving groove 121a in a middle is set to 0.2-2 mm. Of course, this is merely an example, and in practical applications, a range of groove width variation may be adaptively adjusted according to the particle size distribution of the ultrafine powder. It should be understood that along a powder conveying path from the first powder spreading part 11 to the groove-type sieve 12a, the closer the location is to the powder tank 10, the more powder it receives, and on the contrary, the farther the location is from the powder tank 10, the less powder it receives. In order to achieve relatively uniform powder sieving by the groove-type sieve 12a, the groove widths are gradually increased to achieve a more uniform powder discharged from the groove-type sieve 12a, thereby facilitating subsequent powder spreading.

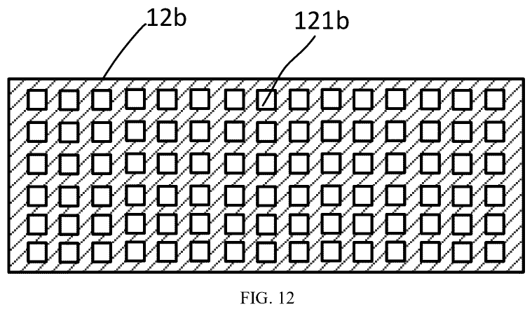

As shown in FIG. 12, in some embodiments, the vibrating sieve 12 may be configured as a perforated sieve 12b. The perforated sieve 12b includes a plurality of powder sieving holes 121b arranged at intervals, and each powder sieving hole 121b has a diameter of 10-30 μm. Although the powder sieving holes 121b shown in FIG. 12 are square-shaped, it should be understood that the powder sieving holes 121b may be presented in other shapes such as circular holes, irregular polygonal holes, etc., in practical applications, all of which fall within the scope of protection of the present invention.

It should be further understood that the powder sieving grooves 121a and the powder sieving holes 121b in FIGS. 11 and 12 are respectively equivalent to the size of the groove-type sieve 12a and the perforated sieve 12b only for the convenience of illustrating their structural relationship, and do not reflect the actual dimensional ratio in actual application.

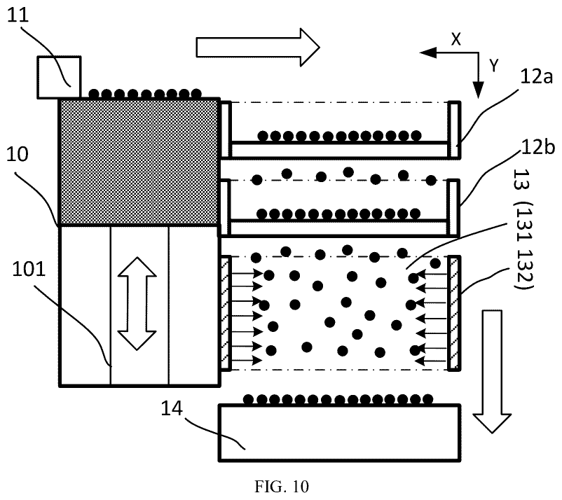

As shown in FIG. 10, in some embodiments, two vibrating sieves 12 may be provided. Specifically, one of them may be configured as the groove-type sieve 12a, and the other may be configured as the perforated sieve 12b, which is preferably used in the present invention. Alternatively, both of them may be configured as groove-type sieves 12a or the perforated sieves 12b. In a specific spatial arrangement, one of the vibrating sieves 12 is arranged in the discharge direction of the powder after being sieved by the other vibrating sieve 12. For example, the perforated sieve 12b is arranged in the discharge direction of the powder after being sieved by the groove-type sieve 12a, which may be understood as the perforated sieve 12b being arranged below the groove-type sieve 12a. After the groove-type sieve 12a sieves the powder conveyed from the powder tank 10 by the first powder spreading part 11, the powder sieved through the groove-type sieve 12a falls into the perforated sieve 12b, the perforated sieve 12b then performs secondary vibrational sieving on the powder discharged from the groove-type sieve 12a to form a two-stage sieving process, thereby improves powder dispersion effect.

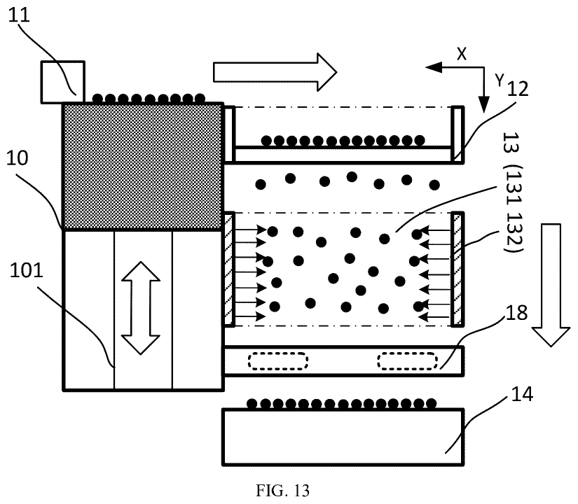

As shown in FIG. 13, in some embodiments, the 3D printing powder spreading apparatus of the present invention further includes a heating device 18, which is disposed above the forming platform 14 and is configured to heat the powder spread on the forming platform 14 via thermal radiation. In a specific spatial arrangement, for example, the heating device 18 is disposed between the forming platform 14 and the plasma mechanism 13, and one end of the heating device 18 is connected to the powder tank 10. The heating device 18 is configured to include a housing with openings at both top and bottom, and include a heating element disposed circumferentially on an inner wall of the housing. A powder dropping channel between the plasma mechanism 13 and the forming platform 14 is formed in an interior of the housing. The heating element may, for example, use infrared heating to heat the powder spread on the forming platform 14 via thermal radiation. In another specific spatial arrangement, for example, a separate driving mechanism is provided to drive the heating device 18 to move from a position away from the 3D printing powder spreading apparatus of the present invention to a position above the forming platform 14 when heating is required, thereby heating the powder spread on the forming platform 14 via thermal radiation.

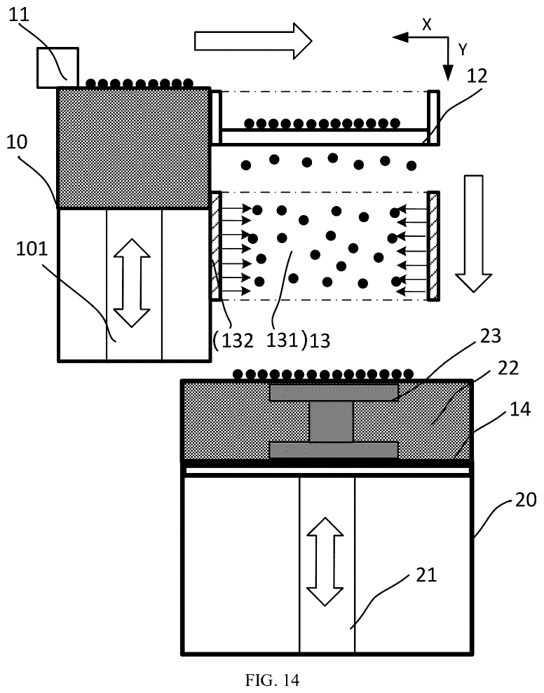

As shown in FIG. 14, in one aspect, the present invention provides a 3D printing device. The 3D printing device includes the aforementioned optical path unit, the computer control system, and a mechanical unit that includes all or part of the structures of the 3D printing powder spreading apparatus of the present invention. The mechanical unit further includes a forming chamber 20. The forming chamber 20 is configured to construct a formed part 23, that is, the formed part 23 is ultimately fabricated in the forming chamber 20. A distance that the forming chamber 20 descends each time is a layer thickness. After the fabrication of the formed part 23 is completed, the forming chamber 20 is elevated to facilitate removal of the formed part 23 and to prepare for the next build cycle. The vertical movement of the forming chamber 20 is driven by a forming lifting mechanism 21. During a fabrication process of the formed part 23, powder is spread layer by layer above the forming chamber 23, that is, the forming platform 14, thereby forming a powder bed 22 above the forming platform 14. In other words, the forming platform 14 of the 3D printing powder spreading apparatus of the present invention is mounted in the forming chamber 20. When the powder bed 22 is formed on a top of the forming platform 14, spreading powder on the forming platform 14 refers to spreading powder on the powder bed 22. It should also be understood that the powder tank 10, the plasma mechanism 13, and the vibrating sieve 12 described above move relative to the forming platform 14, and therefore correspond to movement relative to the powder bed 22/the forming chamber 20.

After the powder spreading process described above is completed, the optical path unit of the 3D printing device is activated to act on the powder on the forming platform 14 to construct the formed part 23.

In some embodiments, the powder tank 10, the vibrating sieve 12, and the plasma mechanism 13 share a drive mechanism a to drive the assembly formed by the three components (named a powder spreading mechanism) to move in the three-dimensional space. A drive mechanism b is configured to drive the forming chamber 20 to move in the three-dimensional space, and a drive mechanism c is configured to drive the optical path unit to move in the three-dimensional space.

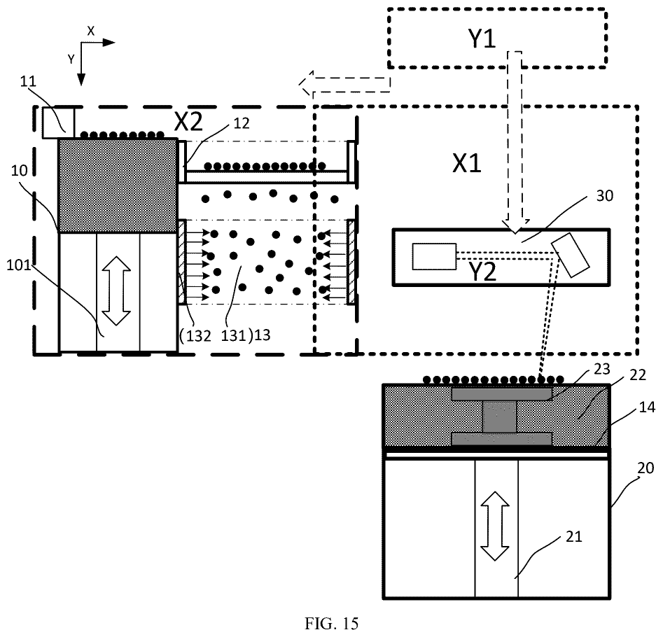

As shown in FIG. 15, in a specific movement control trajectory, after at least one layer of powder has been spread, the drive mechanism a is controlled to drive the powder spreading mechanism to move along the X-axis from Region X1 to Region X2; the drive mechanism c is then controlled to drive the optical path unit 30 to move along the Y-axis from Region Y1 to Region Y2, and the drive mechanism b remains inactive to keep the forming chamber 20 in its initial position, such that the optical path unit 30 is moved above the forming chamber 20 to act on the powder spread on the forming platform 14, thereby constructing the formed part 23.

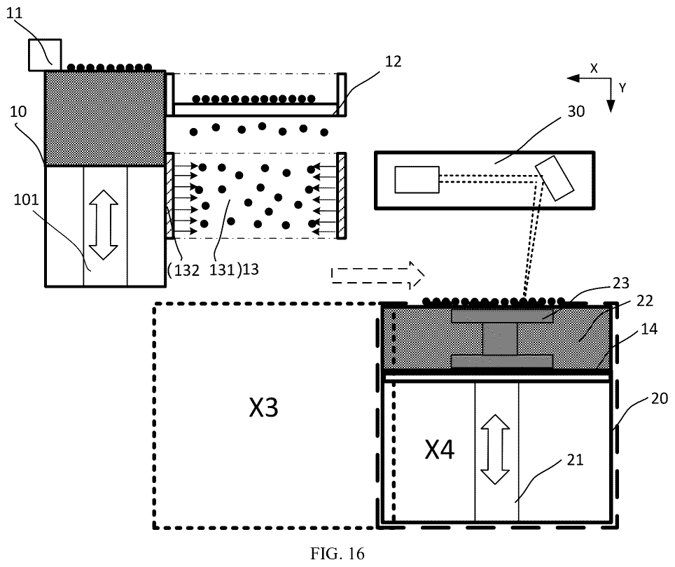

As shown in FIG. 16, in a specific movement control trajectory, after at least one layer of powder has been spread, the drive mechanism b is controlled to drive the forming chamber 20 to move along the X-axis from Region X3 to Region X4, and the drive mechanisms b and c remain inactive, such that the powder spreading mechanism and the optical path unit 30 are both kept in their initial positions, such that the forming chamber 20 is moved below the optical path unit 30, enabling the optical path unit 30 to act on the powder on the forming platform 14, and thereby constructing the formed part 23.

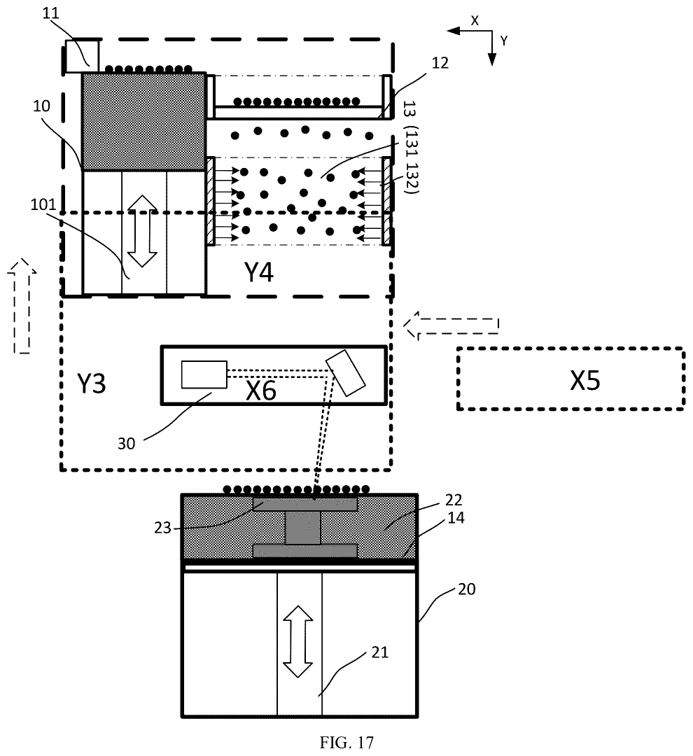

As shown in FIG. 17, in a specific movement control trajectory, after at least one layer of powder has been spread, the drive mechanism a is controlled to drive the powder spreading mechanism to move along the Y-axis from Region Y3 to Region Y4, the drive mechanism c is then controlled to drive the optical path unit 30 to move along the X-axis from Region X5 to Region X6, and the drive mechanism b remains inactive to keep the forming chamber 20 in its initial position, such that the optical path unit 30 is moved above the forming chamber 20 to act on the powder spread on the forming platform 14, thereby constructing the formed part 23.

It should be noted that FIGS. 15-17 illustrate movement control in the X-axis/Y-axis directions. In additional movement control trajectories, control along the Z-axis may also be implemented. Specifically, the drive mechanisms a/b/c may respectively control the powder spreading mechanism/forming chamber 20/optical path unit 30 to move along the Z-axis, such that the optical path unit 30 is moved above the forming chamber 20 to act on the powder spread on the forming platform 14, thereby constructing the formed part 23.

As shown in FIGS. 1-20, in another aspect, the present invention further provides a 3D printing powder spreading method.

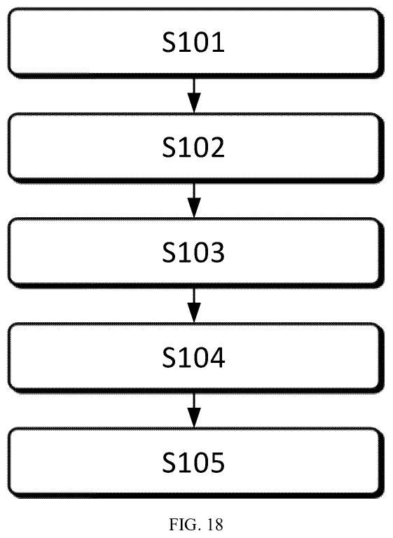

As shown in FIG. 18, the method includes at least steps S101-S105. Specifically, S101: driving a powder tank in which powder is stored for use in 3D printing to move upward, thereby causing part of the powder to overflow from the powder tank; S102: conveying the powder overflowed from the powder tank in a direction away from the powder tank using a first powder spreading part; S103: receiving the powder conveyed by the first powder spreading part and performing vibratory sieving using a vibrating sieve to loosen the powder; S104: releasing plasma to the powder sieved by the vibrating sieve using a plasma mechanism, so as to eliminate static electricity and/or to melt burrs of the powder; and S105: receiving the powder discharged from the plasma mechanism using a forming platform, where the powder is uniformly spread on the forming platform.

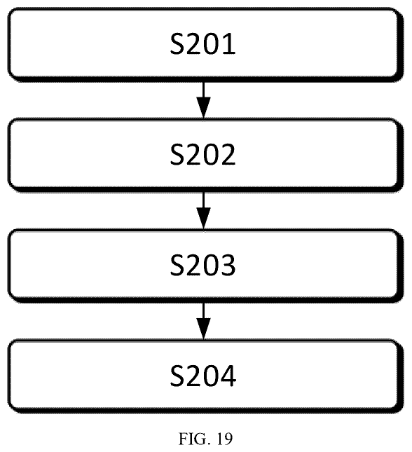

As shown in FIG. 19, optionally, the method includes at least steps S201-S204. Specifically, S201: driving a powder tank in which powder is stored for use in 3D printing to move, thereby causing part of the powder to overflow from the powder tank; S202: conveying the powder overflowed from the powder tank in a direction away from the powder tank using a first powder spreading part; S203: releasing plasma to the powder conveyed by the first powder spreading part using a plasma mechanism to eliminate static electricity and/or to melt burrs of the powder; and S204: receiving the powder discharged from the plasma mechanism using a forming platform, where the powder is uniformly spread on the forming platform.

In some embodiments, the 3D printing powder spreading method of the present invention further includes: rolling the powder entering the vibrating sieve to preliminarily loosen the powder using a second powder spreading part.

In some embodiments, the vibrating sieve includes a groove-type sieve and/or a perforated sieve, where S103 includes: receiving the powder conveyed by the first powder spreading part and performing vibratory sieving using the groove-type sieve to achieve a first-stage loosening treatment; and receiving the powder discharged from the groove-type sieve and performing vibratory sieving using the perforated sieve to achieve a second-stage loosening treatment.

In some embodiments, the 3D printing powder spreading method of the present invention further includes: preliminarily loosen the powder entering the vibrating sieve through ultrasonic waves generated by an ultrasonic mechanism.

In some embodiments, the 3D printing powder spreading method of the present invention further includes: controlling the plasma mechanism to move in the three-dimensional space, such that the powder discharged from the plasma mechanism after treatment is spread on the forming platform according to a predetermined layer thickness.

In some embodiments, the 3D printing powder spreading method of the present invention further includes: measuring a distance from a previous layer of powder to a standard position and a distance from a current layer of powder after spreading to the standard position using a distance sensor, calculating a difference between the distances to obtain a thickness of the spread layer of powder.

In some embodiments, the 3D printing powder spreading method of the present invention further includes: spreading the powder already spread on the forming platform using a third powder spreading part, specifically: controlling the third powder spreading part to move on the forming platform in the powder spreading direction and/or opposite to the powder spreading direction to control the thickness and/or uniformity of the powder spread on the forming platform.

In some embodiments, the 3D printing powder spreading method of the present invention further includes: heating a surface of the third powder spreading part using a heating unit to transfer heat to the powder spread on the forming platform.

In some embodiments, the 3D printing powder spreading method of the present invention further includes: heating the powder spread on the forming platform using a heating device via thermal radiation.

It should be understood that the specific implementation process of the 3D printing powder spreading method of the present invention corresponds to the specific implementation process of the 3D printing powder spreading apparatus of the present invention. Therefore, the detailed implementation process of the method will not be repeated herein.

### REFERENCE NUMERALS IN THE ACCOMPANYING DRAWINGS

10. powder tank; 101. powder-supplying lift mechanism; 11. first powder spreading part; 12. vibrating sieve; 12a. groove-type sieve; 12b. perforated sieve; 121a. powder sieving groove; 121b. powder sieving holes; 13. plasma mechanism; 131. powder dropping channel; 132. plasma generator; 14. forming platform; 15. second powder spreading part; 151. raised portion; 152. recessed portion; 16. ultrasonic unit; 17. third powder spreading part; 18. heating device; 20. forming chamber; 21. forming lifting mechanism; 22. powder bed; and 23. formed part.

What is claimed is:

1. A 3D printing powder spreading apparatus, comprising:
a powder tank configured to store powder used for 3D printing, wherein the powder tank is configured to cause part of the powder to overflow from the powder tank under the action of a drive device;
a first powder spreading part configured to convey the powder overflowed from the powder tank in a direction away from the powder tank;
a plasma mechanism disposed in a discharge direction of the powder after being conveyed by the first powder spreading part and configured to release plasma to the powder to eliminate static electricity and/or to melt burrs of the powder; and
a forming platform disposed in a discharge direction of the powder after being processed by the plasma mechanism and configured to receive the powder discharged from the plasma mechanism, wherein the powder is evenly spread on the forming platform.

2. The 3D printing powder spreading apparatus of claim 1, further comprising:
at least one vibrating sieve disposed in a direction that the first powder spreading part conveys the powder and configured to receive the powder conveyed by the first powder spreading part and to perform vibratory sieving to achieve loosening treatment.

3. The 3D printing powder spreading apparatus of claim 2, further comprising:
a second powder spreading part configured to roll the powder entering the vibrating sieve to loosen the powder.

4. The 3D printing powder spreading apparatus of claim 3, wherein the second powder spreading part is a roller, a lateral surface of the roller is provided with a plurality of raised portions and a plurality of recessed portions at intervals, and a distance between a highest point of the raised portion and a lowest point of the recessed portion is 50-300 μm.

5. The 3D printing powder spreading apparatus of claim 2, wherein the vibrating sieve is a groove-type sieve and/or a perforated sieve.

6. The 3D printing powder spreading apparatus of claim 5, wherein the groove-type sieve is provided with a plurality of powder sieving grooves arranged at intervals, and the powder sieving grooves extend from one end of the groove-type sieve parallel to the direction that the first powder spreading part conveys the powder to the other end of the groove-type sieve.

7. The 3D printing powder spreading apparatus of claim 6, wherein in the direction that the first powder spreading part conveys the powder, groove widths of the powder sieving grooves gradually increase, and the groove widths increase from at least 0.2 mm to 2 mm.

8. The 3D printing powder spreading apparatus of claim 5, wherein the perforated sieve comprises a plurality of powder sieving holes arranged at intervals, and each powder sieving hole has a diameter of 10-30 μm.

9. The 3D printing powder spreading apparatus of claim 5, wherein two vibrating sieves are provided, one of the vibrating sieves is configured as the groove-type sieve, and the other vibrating sieve is configured as the perforated sieve; and one of the vibrating sieves is arranged in a discharge direction of the powder after being sieved by the other vibrating sieve.

10. The 3D printing powder spreading apparatus of claim 2, further comprising:
an ultrasonic mechanism configured to loosen the powder entering the vibrating sieve through ultrasonic waves.

11. The 3D printing powder spreading apparatus of claim 2, wherein the plasma mechanism is in a moving state or in a stationary state in three-dimensional space.

12. The 3D printing powder spreading apparatus of claim 11, wherein when the plasma mechanism is in the moving state, the powder discharged from the plasma mechanism after treatment is spread on the forming platform with a predetermined layer thickness.

13. The 3D printing powder spreading apparatus of claim 11, further comprising:
a distance sensor configured to determine a thickness of a layer of spread powder by measuring a difference between a distance from a previous layer of powder to a standard position and a distance from a current layer of powder after spreading to the standard position.

14. The 3D printing powder spreading apparatus of claim 11, wherein the plasma mechanism moves in synchronization with the powder tank and the vibrating sieve in the three-dimensional space.

15. The 3D printing powder spreading apparatus of claim 14, further comprising:
a third powder spreading part configured to further spread the powder laid on the forming platform.

16. The 3D printing powder spreading apparatus of claim 15, wherein the third powder spreading part is a roller, the roller moves in a powder spreading direction and/or opposite to the powder spreading direction, thereby controlling a thickness and/or uniformity of the powder spread on the forming platform.

17. The 3D printing powder spreading apparatus of claim 15, wherein when the plasma mechanism is in the moving state in the three-dimensional space, the third powder spreading part moves in synchronization with the powder tank, the vibrating sieve and the plasma mechanism.

18. The 3D printing powder spreading apparatus of claim 15, wherein movement of the third powder spreading part is driven and controlled by a separate power source.

19. The 3D printing powder spreading apparatus of claim 15, wherein the third powder spreading part is provided with a heating unit for heating a surface of the third powder spreading part to transfer heat to the powder spread on the forming platform.

20. The 3D printing powder spreading apparatus of claim 15, further comprising:
a heating device disposed above the forming platform for heating the powder spread on the forming platform via thermal radiation.

21. The 3D printing powder spreading apparatus of claim 1, wherein the plasma mechanism comprises a powder dropping channel and at least one plasma generator arranged on the powder dropping channel; and after the conveyed and discharged powder enters the powder dropping channel, the plasma generator is configured to release plasma to the powder entering the powder dropping channel to eliminate static electricity and/or to melt burrs of the powder.

22. The 3D printing powder spreading apparatus of claim 2, wherein a vibrating frequency of the vibrating sieve is 500-3000 Hz.

23. A 3D printing device, comprising a structure configured to mount the 3D printing powder spreading apparatus of claim 1 into the 3D printing device.
